(19) United States
(12) Patent Application Publication
(10) Pub. No.: US 2003/0011630 A1
(43) Pub. Date: Jan. 16, 2003

(54) Self instructional authoring software tool for the creation of a multi-media resume

(76) Inventors: Ruth Helene Knowlton, Houston, TX (US); Diane Elizabeth Dieter Hughes, Houston, TX (US)

Correspondence Address: RUTH HELENE KNOWLTON, 9206 TISH COURT, HOUSTON, TX, 77040, US

(21) Appl. No.: 09/903,417

(22) Filed: Jul. 12, 2001

(51) Int. Cl. G09G 5/00

(52) U.S. Cl. 345/731

(57) ABSTRACT

This invention is a self-training, interactive, multi-media authoring tool that uses computerized methods and systems to produce multi-media resumes which can be outputted in any combination and at the user's discretion can be E-mailed, posted to a website, printed or written onto external media such as a disk or CD. The invention uses a graphical user interface and creates interactive dialogue between the user and the software. It uses the user's own selected media; specific types supported are defined by the user. Media assets can be selected from a file or captured in real-time during resume creation and written to a file. Resume elements written to files are tagged with identifiers. By using a keyword search feature, the user's family of resumes and/or a data bank of resumes can be searched against job criteria. All relevant resumes can then be compiled onto a single submission. A processor plays back the resume and facilitates editing. The system then automatically generates the web code needed for the production of the composited resume(s) and thusly it integrates all assets to produce an interactive multi-media resume. The user can select various format styles of output and preview assets. This invention creates billing information and is user friendly for a system administrator to create, inactivate, back up files, password protect. The software can be run from a web-connected server or from the Internet host server.

### CROSS REFERENCE TO RELATED APPLICATIONS

5983218 November 1999 Syeda-Mahmood 707/3 5659793 August 1997 Escobar et. AL. 345/302

### BACKGROUND OF INVENTION

It is common practice for individuals seeking jobs to present their qualifications to a prospective employer using a Resume of Qualifications, also known as Curriculum Vitae. It is also common practice for employers to require that form of communication from prospective applicants. Historically, these resumes were prepared by hand, and then typewritten. With the advent of the widespread use and distribution of computers, several commercially available resume software systems have become popular. An example of this is Microsoft's Publisher software. The software allows the user to select a format and enter the information into a template. The viewer sees how the resume will appear as they are entering the information. These systems are typically limited to text-based printed resumes. The printed resumes can be attached to an email but they are still just electronic images of the printed resume and are not interactive.

Now, commercial Internet services such as resume.com and minuteresume.com enable an individual to create a resume on-line, print the resume and/or email it. The site 10 minuteresume.com helps the user to post their finished resume to a web site. However, these are still text-based resumes, containing no sound, video or other new media, and they are not interactive. Many of those businesses have failed.

Due to the cyclic nature of business, a downturn in a given industry can cause thousands of workers to be laid off during the same general time period. Many of them with the same backgrounds and skill sets can be applying for the same job opening. Therefore, with so many similarities in resume formats and content, additional differentiation is needed so that an individual can make it through the first screening of candidates to the interview step. The inclusion of media can be such a differentiator.

Yet the inclusion of media elements requires specialized knowledge of the use of media software programs and file formats. Very few members of the general public are familiar with these software packages. Even fewer have any idea how to incorporate media wisely into a resume so that the results are a concise, yet engaging and informative pseudo-interview.

In order to find matches between job seekers and jobs available, data items about both need to be tagged for recognition by search engines. Tags should identify personal information about qualifications and experience as well as job objectives. These tags should be according to an open architecture, such as XML, to facilitate searches by a number of engines. Furthermore, the media elements within the inner workings of the resume should identify the media elements internally with tags to support searches by the individual user during the resume creation process.

### SUMMARY OF INVENTION

The objective of this invention is to help job seekers secure the job they desire and for which they are are qualified, by allowing them to provide better insight into their qualifications through the use of media, such as narration, pictures, animation, video clips and other portfolio pieces. The inventors recognize that an individual may want to customize their resumes according to market sector or specific employer. Therefore, in addition to supporting an unlimited number of users, this invention supports multiple resumes for an individual. Each version of the resume is identified by a title supplied by the user and is accessible by the individual composer of the resume and the administrator until only the job seeker

The invention can be hosted on an internet or intranet server, on a Local Area Network server with internet connection, or on a stand-alone personal computer which has been configured as a media workstation with scanner, video, microphone, printer, CD burner, and other media peripherals, and connected to the internet.

The inclusion of the media is done in such a manner as to link the media to a particular item within the resume. For example, an individual may choose to use a 10 second video close-up as an introductory piece in place of the traditional cover letter. A Flash animation might better help explain a new process that a management or technical candidate developed. The individual may choose narrations at the beginning of one resume and in the next resume, may decide to have a musical opening. In either case, the media is not extraneous, but provides an improved description of the candidate's qualifications, showing both tangible results, such as accomplishments achieved and the candidate's intangible assets, such as personality, which can be critical in securing a management position, a position where working with the public is required or any position where you are a part of a team.

This invention is “user friendly”. It has a wizard that provides instructions to the individual user through each step of the media creation process through its graphic user interface feature. This wizard can be multi-lingual, allowing the user to select the language of choice for the narration. This feature raises the comfort level of an individual who has never used a computer before. It allows the novice to produce a dynamic media creation that can then be outputted in the format and to the medium they select. They do not need any prior knowledge of any kind about the Internet. In this invention, the software interface allows the individual to perform such specific media functions as to create and/or play audio clips, create and/or play video clips, operate a scanner, burn a CD, write to a disk, import media files as well as text files, and convert file formats, in step by step narrator directed instructions. The individual can also dynamically link to other media software packages that reside on the main system. All of this is controlled by the multimedia interface component of this invention, which facilitates the user being able to, at run time, dynamically capture media for inclusion into the resume; said media being sounds, pictures, video clips, text-based presentations; said media being captured by an application specified by the user; said media being captured by the specified software application while under the direction of a graphical user interface and instructions supplied by this system; said interface being of such as self-explanatory nature and detail that the user need have no prior experience using the application under control of this system to achieve success at capturing the media. The invention allows the output to be viewed inside a web browser prior to acceptance for publication to an output media and supports the user's selection of output media; said output formats being upload to a web site, output to a mass storage device such as CD, floppy or high storage media such as Zip or jazz, an attachment to an email, printed copy, or copy to another location on a hard drive. The invention can also automatically compress file formats to support the presentation of the resume with the desired output format; said processor giving an error message to the user if the file sizes cannot be compressed to a suitable size for transmission or viewing; said processor looking at space available on the output media or appropriate for transmission, and the file size of the integrated resume. The individual also have a choice of output style and “look and feel”. The invention provides the individual choices of various pre-programmed output formats. These output formats have text, photos and/or videos in different spaces on the page thusly allowing for the individual to express their own person preference as to the “look and feel” that they want to project to a prospective employer. For example if an individual was seeking a position in a publishing firm which produces official documents, they would want to present the output of their resume differently than if they were seeking a position with a magazine publishing company. The invention allows the individual to store their resumes after they have gotten their desired job position for retrieval in the future. This benefit within the invention is important because statistics point to the fact that most individuals go through five careers in their lifetime. Since the resumes can be updated through the editing process, individuals can come back in two hours, two weeks, two months, two years or anytime and revamp and/or revise their resume.

This invention is also “administrator/caseworker friendly” because it walks and talks the administrator through all aspects of the resume process. This includes both the storage of previous resumes and the interface with the jobs database. This is helpful to the company which is implementing this invention because there is no training involved when they have personnel turnover. The only requirement is a computer or work station which is connected to one or more output devices or on a local area or wide area network server which can be accessed by individual clients connected to that server or on an Internet server which can be accessed by individual subscribers. The invention can support an unlimited number of users; said users having the capability to have multiple resumes within their files; said users being able to access media in their own private media library or in a global system library; said user directories, files and libraries being protected from access by other users. The invention also has a component for use by a system administrator who is able to add new user information to the system, inactivate users, locate user passwords, perform system back-ups, change software applications available for support under the control of the resume system; said component having a graphical user interface and self-instructional elements such that no formal training is required to effectively use the system. The invention also allows an administrator or case manager to compile resumes of one or more applicants for submission to a prospective employer. The applicants keep resume elements on file that match specified job search criteria. The invention allows a case manager or administrator to interview a candidate by a standard video conference software application, record selected elements of the conversation suitable for submission to a perspective employer, and include that recording with the applicant's resume or cover letter. All of this is done with ease thanks to the inventions narrator controlled talk which takes one through the process step by step.

The administrator/caseworker doesn't require the knowledge of any computer language such as HTML because the invention generates the code for the individual users media resume allowing the caseworker to funnel the resume straight to the desired destination of the individual client desires. The invention also contains its own library of buttons and other navigational elements needed to display the resume output in the selected format, with the appropriate functionality for the media types; said functionality being specific media players, such as but not limited to Real, Microsoft, QuickTime and Macromedia players; said players being automatically included according to media type and selected display format and output media.

Additionally, the media is tagged with descriptors so that searches can be conducted through the use of media libraries. These tags include media type, title, keywords or phrases, user-supplied descriptions, and descriptors set or identified by the media processor such as file size, image height and width, movie run time and dates of creation or modification, and cross reference information such as where and how the media has been used. For example, a narration might be used in the introductory portion of the user's first resume, then in the accomplishments section of the user's third version of his resume. The individual has the ability to store media and arrange it at will to accommodate whichever type of resume that is needed or desired.

The resume also contains tags to facilitate the search of an entire databank of resumes against job openings requirements. This invention plugs into job opening data banks, training databases, reference databases as well as generating billing information. Individuals have a better chance of finding their desired job because the invention allows them to view which jobs are available, for what salary and in what location. This cuts down on tedious trips and interviews to job openings that are of no real interest to the individual. The individual can use the information in the jobs database to decide how they are going to tailor their resume so it is compatible with the job opening that they desire. The individual also has the opportunity to get job training in order to qualify for a specific job opening and they have the ability to use the reference database to find out more about what the prospective company is looking for.

### BRIEF DESCRIPTION OF DRAWINGS

The accompanying drawings, which are incorporated in and form part of the specification, illustrate an embodiment of the present invention and, together with the description, serve to better explain the operational features, and advantages of the invention. It should be understood, however, that the invention is not limited to the precise arrangements and instrumentalities shown.

FIG. 1 illustrates a typical system architecture for the system of processors and data;

FIG. 2 is a block diagram illustrating the elements of the media management processor

FIG. 3 illustrates the block diagram architecture for the administrator and caseworker processor;

FIG. 4 illustrates the architecture for the output generation processor;

FIG. 5 is a block diagram illustrating the architecture of the primary user interface for the resume generator processor;

FIG. 6 illustrates the invention, a self-instructional authoring software tool for the creation of a multi-media resume.

### DETAILED DESCRIPTION

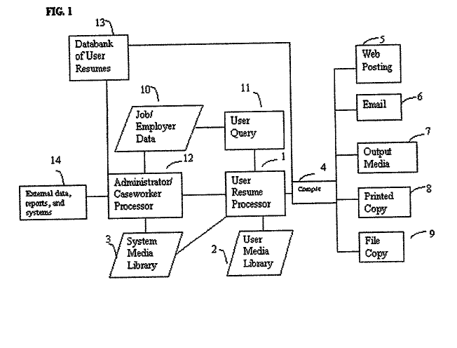

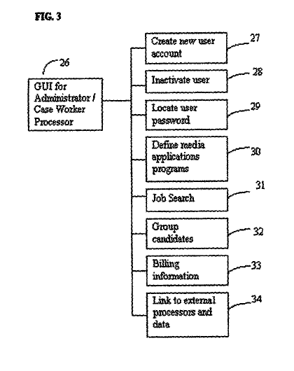

This invention is a Self Instructional Authoring Software Tool for the Creation of a Multimedia Resume. Prior to discussing the multimedia database design, we need to get a general overview of the system. FIG. 1 illustrates the typical system architecture for the system of processors and data. As you can see in this figure, there are fourteen specific components, which comprise the processor and data. 1, user Resume Processor allows the individual user to create a resume which contains visuals and sound. 2, user media library allows the user the opportunity to store data in various forms, i.e. pictures, videos, narrations and music and then these said items can be reused over and over in various Resumes and formats. This library set is solely for the individual user and may not be accessed by other users. 3, system media library contains generic information that can be obtained and used by all users. 4, compile allows the user to pull all aspects of the Resume together and then decide which output format to use. 5, web posting is just one of five ways that a user can select which permits them to export their Resume. The web posting allows them to choose a URL and then place it on that site. 6, Email is the second output function, which allows the user to send the Email to various addresses, which are not exclusive to prospective employers but can go anywhere. 7, output media covers various external removable, transportable ways to export your Resume. They include: Zip disks, 3½ inch Floppy disks, Jazz and CD as well as any new technology which allows one to export media and carry it off, printed copy lets the user print out the Resume in the normal sense with graphics in tact in the format that they select. 9, file copy permits the user to put the Resume to a file where it can be retrieved and exported and/or edited at a later date. 10, job/employer data is a function of this system, which allows the user to view jobs, which he/she is qualified for in order to get employer information. The administrator also has access to this feature allowing them to match clients to prospective employers. 11, user query allows the user to put in a keyword to access the database which contains employment opportunities. 12, administrator/caseworker processor allows for the flexibility of user information retrieval and dismissal as well as many other features. (Refer to FIG. 3) 13, databank of user resumes stores an unlimited number of resumes to be stored and then later retrieved by an administrator/ caseworker, a user, prospective employer, and/or a business partner. 14, external data, reports and systems are produced to let the administrator get figures on the successful employment or placement of clients and any other required reports which need to be generated by the administrator/caseworker. This allows them to link to outside systems such as Federal, State and Local Agencies.

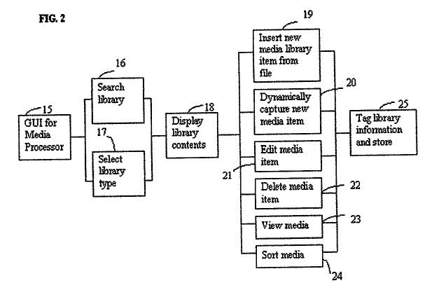

In FIG. 2, a block diagram illustrates the elements of the media management processor of this invention. 15, GUI for media processor is a graphical user interface, which allows the user to go through the system by way of visuals and verbal prompting. 16, search library is a feature that displays the various media categories that can be accessed by the user. They include: photos, sound, video, text, flash, real media and pdfs. 17, select library type now allows the user to go into the above stated media categories in order to update, delete or add to the selected category. 18, display library contents let the user view the items that are in the selected category. 19, insert new media library item from file gives the user the opportunity to go into the computer system and import the media from a file. The file can be on the computer system, a CD, a Zip, a 3½-inch Floppy or jazz. 20, permits the user to dynamically capture a new media item, to scan in media, record their voice and/or capture video, all with no prior experience. 21, edit media item gives the user the freedom to edit or change any item that they select and it walks them through each step with narrative instructions. 22, delete media item lets the user pick and choose which items stay and which go. 23, view media is a feature where the user can view the media selections they have under their name and password. 24, sort organizes the media by fields either by name or type. 25, tag library information and store by the following methods: file size, dates, height, width, duration, title, subject, description, author and/or keywords.

FIG. 3 illustrates the block diagram architecture for the administrator and caseworker processor. 26, GUI for administrator/caseworker processor permits the administrator/caseworker the freedom to perform many functions with the invention. 27, create new user accounts function allows the administrator/caseworker to add new users to the system. 28, inactive user component makes it possible for the administrator/caseworker to put the inactive clients into a folder within the invention and can be retrieved at a later date if necessary. 29, locate user password gives the administrator/caseworker the ability to find and/or retrieve forgotten or misplaced passwords for clients as well as assign passwords to new clients. 30, define media applications programs allows the administrator/caseworker to input the specific supportive media players that function best on their main computer system. 31, job search feature allows the administrator/caseworker to search for specific jobs, which match clients Resumes. 32, group candidate permits the administrator/caseworker to rank by number the top candidates in a specific pool for a specific employment opportunity. 33, billing information lets the administrator/caseworker interface with an existing billing system or interface with a credit card system over the Internet and keep billing records on their clients. 34 link to external processors and data gives the administrator/caseworker the ability to plug into the State, Local and Federal URL sites and transfer information or generate reports.

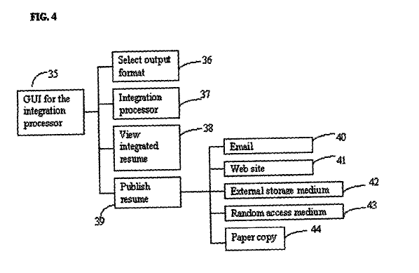

FIG. 4 illustrates the architecture for the output generation processor. 35, GUI for the integration processor is a graphical user interface that allows the user to go through the system. They are prompted by easily understandable visual queues and verbal prompts. 36, select output format permits the users to select the format that they want to use in the output of their final resume. 37, integration processor compiles all the user information into a viewable format. 38, view integrated resume gives the user the opportunity to view the compiled resume to make sure it looks the way they want it to before it is published. 39, publish resume allows the user the freedom to choose which avenue of output they desire for their resume. 40, Email as mentioned in FIG. 1 is one way that a resume can be published. 41, website is a location where a users resume can be published. 42, external storage medium allows the user to publish their resume to a Zip, CD disk, 3½ inch Floppy or Jazz. 43, random access medium allows the user to publish their resume to the computer systems hard drive or to a Local Area Network server or a Wide Area Network server. 44, paper copy can also be generated and published by the user if that is what they desire.

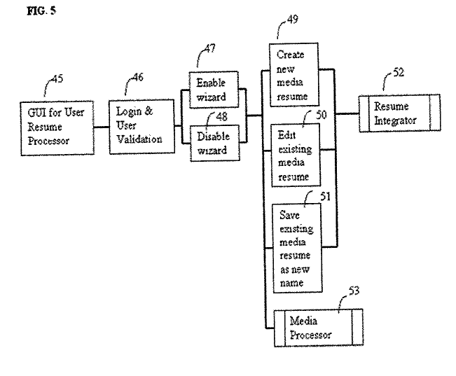

FIG. 5 is a block diagram illustrating the architecture of the primary user interface for the resume generator processor. 45, GUI for user resume processor takes the user from screen to screen in the invention with easily understandable visual and verbal instructions. 46, login & user validation assures the user security in the login process through the use of passwords. 47, enable wizard is a function within the system, which allows the user to use a wizard who verbally leads them through each step of the resume creation process. 48, disable wizard is a feature in the system that allows a user to go through the system without any assistance, 49, create new media resume enables the user to build a new resume. 50, edit existing media resume is a feature which lets the user change or edit a previous resume to update it or change it in any way that they choose. 51, save existing media resume as new name allows the user to change the way a resume is saved for retrieving at another time. 52, resume integrator is a subroutine or stand-alone program which can be called as apart of the invention to integrate the resume components. 53, media processor is also a stand-alone program which allows the invention to manage the media.

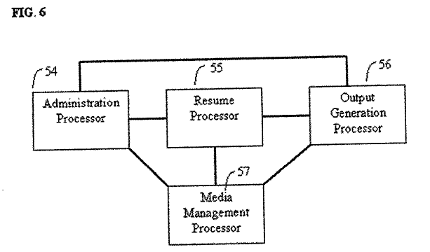

FIG. 6 illustrates the invention, as a self-instructional authoring software tool for the creation of a multi-media resume. 54, administration processor is a component of the invention that gives administrators/caseworkers the ability to interact with their client's resumes and media in order to help them to gain employment. 55, resume processor gives a job seeker or user the ability to create a dynamic, media enhanced resume. 56, output generation processor gives the user the freedom to output their resumes for submission in various outputs (see FIG. 1). 57, media management processor gives administrators/caseworkers the opportunity to easily manage and keep reports and records for various clients who are seeking employment.

1. A computerized software system which is used to produce electronic resumes which contain audio and/or visual media elements to illustrate the text items; said software being authored with a multi-media tool, having interactive self-training features for both end user and administrator so that they may use the system without the need for any formal training; said software using and generating data files and elements for resumes, linking and including a full spectrum of audio and visual media; said software generating its own code for a compressed format output, capable of being presented over the internet or delivered by email; said software system supplying the style templates for the end user to select the style of output presentation and mode(s) of delivery.

2. A system according to claim 1, which can reside on a stand-alone computer or workstation connected to one or more output devices, or on a local area or wide area network server and accessed by users connected to that server, or on an Internet server, which can be accessed by subscribers.

3. A processor according to claim 1, which controls the operation of other media software through an instructional graphical user interface, having audio directed interactions; said software to perform such specific media functions as to create and/or play audio clips, create and/or play video clips, operate a scanner, burn a CD, write to a disk, import media files as well as text files, and convert file formats, as needed.

4. A processor according to claim 3, the allows that user to dynamically link to other media software packages residing on their system, under the control of a multi-media interface, and storing the results in data files for later use by the system.

5. A processor according to claim 3, which enables the user to add to the media library, delete from the library, or make edits to the contents of the media library, and otherwise manage the content of the media library with tags, keywords and descriptors.

6. A processor according to claim 3, which facilitates the user being able to, at run time, dynamically capture media for inclusion into the resume; said media being sounds, pictures, video clips, text-based presentations; said media being captured by an application specified by the user; said media being captured by the specified software application while under the direction of a graphical user interface and instructions supplied by this system; said interface being of such a self-explanatory nature and detail that the user need have no prior experience using the application under control of this system to achieve success at capturing the media.

7. A processor according to claim 1, which tags the data files and elements with information to enable searches; said searches being able to locate media files of a certain type, size or content; said searches being able to identify a resume of a certain title or content; said searches being able to identify matches between the databank of resumes and specific job criteria.

8. A system according to claim 1, which links data elements within the databank of resume information to other relevant data files external to the resume application, such as billing information, job openings data banks, training databases and reference databases.

9. A processor according to claim 1, which allows the format of a resume to be selected by the end user from a collection of templates.

10. A processor according to claim 9, which integrates all selected information, text, and media assets, and automatically generates generic web-enabled program code to display that selected information, text and media assets according to the chosen format.

11. A processor according to claim 9, which contains its own library of buttons and other navigational elements needed to display the resume output in the selected format, with the appropriate functionality for the media types; said functionality being specific media players, such as but not limited to Real, Microsoft, QuickTime and Macromedia players; said players being automatically included according to media type and selected display format and output media.

12. A processor according to claim 9, which allows the output to be viewed inside a web browser prior to acceptance for publication to an output media.

13. A processor according to claim 1, which supports the user's selection of output media; said output formats being uploaded to a web site, outputted to a mass storage device such as CD, floppy or high storage media such as Zip or Jazz, an attachment to an email, printed copy, or copy to another location on a hard drive.

14. A processor according to claim 13, which can automatically compress file formats to support the presentation of the resume with the desired output format; said processor giving an error message to the user if the file sizes cannot be compressed to a suitable size for transmission or viewing; said processor looking at space available on the output media or appropriate for transmission, and the file size of the integrated resume.

15. A system according to claim 1, which can support an unlimited number of users; said users having the capability to have multiple resumes within their files; said users being able to access media in their own private media library or in a global system library; said user directories, files and libraries being protected from access by other users.

16. A system according to claim 1, having a component for use by a system administrator; said administrator being able to add new user information to the system, inactivate users, locate user passwords, perform system backups, change software applications available for support under the control of the resume system; said component having a graphical user interface and self-instructional elements such that no formal training is required to effectively use the system.

17. A processor according to claim 16, which can allow the end user to perform many of the elements of a system administrator without the intervention of a human; said elements being new user information, billing information, password maintenance, and application definition.

18. A processor according to claim 16, which allows an administrator or case manager to compile resumes of one or more applicants for submission to a prospective employer; said applicants having resume elements on file that match specified job search criteria.

19. A processor according to claim 16, that allows a case manager or administrator to interview a candidate by a standard video conference software application, record selected elements of the conversation suitable for submission to a perspective employer, and include that recording with the applicant's resume or cover letter.
